(19) United States
(12) Patent Application Publication
(10) Pub. No.: US 2016/0252893 A1
(43) Pub. Date: Sep. 1, 2016

(54) Robotic Self-Service Device and Methods for Banking and Vending

(71) Applicant: Quantum Systems, Inc., Miramar, FL (US)

(72) Inventor: Alexander Vadimovich Kamyshnikov, Moscow (RU)

(21) Appl. No.: 14/943,397

(22) Filed: Nov. 17, 2015

(30) Foreign Application Priority Data
Feb. 26, 2015 (RU) RU2015106560
Apr. 28, 2015 (RU) RU2015115972
Aug. 26, 2015 (RU) PCT/RU2015/000538

(51) Int. Cl. G05B 19/10; G06Q 20/10; G05B 19/416; G06Q 20/18

(52) U.S. Cl. CPC G05B 19/106; G06Q 20/18; G06Q 20/108; G05B 19/4166; G05B 2219/2645; G05B 2219/40252

(57) ABSTRACT

A robotic self-service device with a portable and modular structure and various components to provide multiple consumers with simultaneous automated vending services and vending goods. The robotic self-service device provides secure access and secure valuables storage. The robotic self-service device provides for efficient currency validation, storage, exchange, and dispensing as well as storage and dispensing of other vending goods. The robotic self-service device has robotic manipulators controlled by a control unit preprogrammed with algorithms that allow the robotic manipulators to adapt to different tasks commanded by consumers, to adapt to various banking services, and to provide various vending goods. The robotic manipulators coordinate tasks between working areas and gateways. The robotic self-service device is portable and modular.

### CROSS REFERENCE TO RELATED APPLICATIONS

This application is a continuation-in-part of International Application PCT/RU2015/000538 with an international filing date of Aug. 26, 2015, and which claims the benefit of Russian Federation Application RU2015106560 with a filing date of Feb. 26, 2015 as well as Russian Federation Application, RU2015115972 with a filing date of Apr. 28, 2015.

### TECHNICAL FIELD

The present disclosure relates to methods and apparatuses for multi-functional, compact structures containing robotic self-service devices. The present disclosure pertains to robotic self-service devices that can be assembled and installed quickly on site in consumer areas such as banks, shopping malls, supermarkets, railway stations, or airports in order to provide quick, automated, and secure service for various banking and retail needs. More specifically, the present disclosure presents devices for cash-in and cash-out, currency exchange, obtaining and submitting various bank documents, credit card issuing, bill payments, goods vending, and for storing cash and valuables in cassettes and other storage systems. The disclosed devices could also be used for transmittal of transaction data to an entity's information system, cash collection at the close of business, and for various information services.

### BACKGROUND

Traditionally, currency and/or goods vending machines have been large, bulky, perform a single or limited function, and are slow. Vending is the sale of goods and services via automated systems (ATMs). Vending is popular and widespread in the world as a comfortable and less demanding way to provide retail services. Vending has existed for more than a hundred years. Traditionally, a vending machine is a machine that dispenses items such as snacks, beverages, cigarettes, or lottery tickets to consumers automatically after the consumer inserts currency or a credit card into the vending machine.

The first modern vending machines were developed in England in the early 20th century and dispensed postcards. The first vending machine in the United States was built in 1888, selling gum on New York City train platforms. Such vending machines quickly found admirers, and the vending services industry began to grow rapidly.

There are about 20 million various vending machines installed and operating worldwide. The most powerful vending market presently is in Japan where the turnover of those services is about 70 billion dollars. In Europe, one vending machine is accounted for 120 people. In the United States, one vending machine is accounted for 20 people. In Russia, one food vending machine is accounted for 100 thousand people, where most of those machines are used for the specific purposes as ATMs, ticket kiosks, and/or vending machines.

At the present, the most widely and frequently used automated machines are bank terminals that essentially perform one to two bank operations: cash deposit and cash withdrawal. These terminals serve one customer at a time. Currently, it is not possible to increase the capacity of such equipment. Currently, there are no complex automated services for vending services other than for banking. All automated devices have a specific purpose and non-mobile design.

For example, Russian patent application number 146027 discloses an ATM that contains anti-vandal housing with the front panel display and keyboard, control unit, printing apparatus, coin dispenser, card-reader, and information transfer unit mounted inside the housing.

An additional information display for advertising and/or searching for information upon customer request mounted on the front panel is also described.

Patent application RU148187 discloses a multifunctional ATM with anti-vandal housing and a font panel display and keyboard, that comprises at least two cash-out units, each of which is configured to issue various currencies, and one of them is equipped with a recycling system and a unit for banknotes sorting, as well as card-reader, block for the cards issuing and storage, control unit, and a vending block.

Publication JP 7-160929 discloses an automatic dispenser with a cash controlling function. This function solves the problem of cash counting by using a cash transactions robot. This robot automatically adds banknotes to the dispenser when it runs out of cash.

A current system for a local banknotes circulation is named Q-Cash Router (www.countingoncurrency.com, Nov. 14, 2012. This structure is equipped with four ATM panels; the main panel is used for accepting unsorted stacks of banknotes. Two side panels are intended for cash-out operations. A fourth panel is mounted on the housing backside and is intended for bank staff usage. This structure significantly improves the efficiency of cash turnover since the bank's customers who want to withdraw money do not have to wait to be serviced by tellers.

However, the capacity of such device is limited since it could only serve for cash-in and cash-out. Because of that, there is no flexibility or ability to reconfigure such system. The system is not universal because it could not process operations other than cash-in and cash-out.

### SUMMARY

What is needed is a structurally independent mobile, robotic device intended for quick on-site assembly and installation, to provide complex and multi-function customer service, produce high-speed performance, and can be used simultaneously for various banking, retail, and vending services, is efficient, and is eco-friendly.

Specifically described herein is a robotic self-service device comprising an electrically-powered robotic complex; an access device electronically connected to a control unit, the control unit comprising a processor, random access memory, and digital storage; a gateway; an interior working area; a storage compartment; and an access window. The device has a modular and portable structure wherein the device is defined by a three-dimensional frame with sides and vertices having attached panels providing facets and providing an interior and an exterior defining a device cell and has a frame docking unit at frame vertices for mechanically attaching a cell on up to each facet of a three-dimensional cell. The device is easily transported by land, sea, or air.

Also described is a method for providing portable vending services entailing fixing the device to a transportation means and transporting the device to a desired location, and connecting the control unit to a power supply, wherein the control unit is connected to a network. The access device accepts commands from consumers, the access device sends the commands to the control unit, the control unit processes the commands and sends the processed commands to the robotic complex, and the robotic complex accepts the processed commands and executes the processed commands. The robotic complex completes the tasks and dispenses the vending goods the consumer requested.

A method for providing simultaneous vending services to multiple consumers is described. A consumer approaches one cell of the device wherein the cell comprises an access device and a gateway fixably integrated into the device cell panel. At least one more consumers approaches a second cell of the device wherein the cell comprises an access device and a gateway fixably integrated into the device cell panel. All consumers initiate access and input commands on the access device. The control unit processes commands and signals the commands to the robotic complex. The robotic complex executes the commands. The robotic performs vending services, provides complex provides currency, material objects such as coins, bullions, cassettes and vending goods at each gateway, and the consumers retrieve these goods at the gateway.

### BRIEF DESCRIPTION OF THE DRAWINGS

The accompanying drawings that are incorporated in and constitute a part of this specification illustrate several embodiments of the disclosure and, together with the description, serve to explain the principles of the disclosure:

FIG. 1 illustrates an exemplary embodiment of a modular robotic self-service device.

FIG. 2 illustrates an exemplary single-cell robotic self-service device.

FIG. 3 illustrates an alternative exemplary embodiment of a robotic self-service device having two cells.

FIG. 4 illustrates an exemplary mobile robotic self-service device.

FIGS. 5.1 and 5.2 illustrate an alternative mobile robotic self-service device.

FIG. 6 illustrates exemplary method steps for cash-in operation.

FIG. 7 illustrates exemplary method steps for cash-out operation.

FIG. 8 illustrates exemplary method steps for functionality processes of a robotic self-service device.

FIG. 9 illustrates an exemplary schematic for movement of material objects within a robotic self-service device.

FIG. 10 illustrates an exemplary schematic for movement of robotic manipulator between the cells.

FIG. 11 illustrates an exemplary schematic for client and service gateways.

FIG. 12 illustrates an exemplary schematic for robotic self-service device processes.

### REFERENCE NUMERALS OF THE DRAWINGS

The following list refers to the drawings:
1. Housing
2. Cell
3. Robotic manipulator
4. Interior working area
5. Gateway
6. Robotic-manipulator grab
7. Robotic manipulator base
8. Rail
9. Vending goods (including currency and coins)
10. Exterior working area
11. Access window
12. Secondary robotic complex
13. Frame
14. Panel
15. Frame docking unit
16. Access device
17. Storage compartment
18. Currency counter apparatus
19. Counterfeit detector apparatus
20. Currency dispenser apparatus
21. Printing apparatus
22. Currency receptacle
23. Control unit
24. Armored panel
25. Network connection

### DETAILED DESCRIPTION

### Introduction

The present disclosure provides generally for methods and apparatuses for robotic self-service devices for banking and retail services. The robotic self-service device described herein is not a traditional vending machine but is a machine that dispenses items such as coins, bullions, cassettes, currency, mail, lottery and other tickets, and vending goods to consumers automatically after the consumer inserts currency or credit card into the machine. The robotic self-service device described herein relates to the field of multi-functional, compact structures containing robotic arms and is intended for quick on-site assembly and installation in order to provide streamlined, automated, and secure service for various banking and retail industries and for consumers.

In order to reduce the large amount of manual work and transportation of valuables between consumers, retailers, banks, currency exchange centers, and the Central Bank, a quick, automated and secure device and service for various banking and retail needs is disclosed. Significant savings could be achieved if banknote circulation occurs locally, money is used repeatedly, and services for various banking and retail needs are automated and secure. Furthermore, automated banking and retail services are more accessible to consumers due to its compact size and efficiency. Therefore, more consumers are served in a shorter amount of time. For example, many robotic self-service devices for currency exchange can be installed in airports to reduce lines for international travelers. Furthermore, mobile self-service devices may be implemented at short-term events and festivals.

The robotic self-service device could be used for cash-in and cash-out, currency exchange, obtaining and submitting various bank documents, credit cards, bill payments, and for storage of cash and valuables in cassettes and other storage systems. The robotic self-service device could also be used for transfers of transaction data to the company's or bank's information system, cash collection at the end of the day, and for the various information services.

A robotic self-service device may contain a case or housing consisting of separate cells that are joined to each other and may be modular. These cells may form a housing protecting the interior from unauthorized access. Inside the interior, a robotic manipulator with a control unit is placed. Within the same housing, there are working areas (kiosks, or certain openings/gateways, or terminals) intended for performing or designated space for performance of automated robotic operations. Cells also may have gateways for the deposition and withdrawal of objects and papers. A robotic manipulator grab is intended for multiple movements between working areas and gateways upon the corresponding commands from the control module. The robotic self-service device as a whole increases operational speed while providing a wide range of automated consumer self-services.

In the following sections, detailed descriptions of examples and methods of the disclosure will be given. The description of both preferred and alternative examples are exemplary only, and it is understood to those skilled in the art that variations, modifications, and alterations may be apparent. Therefore, the examples do not limit the breadth of the aspects of the underlying disclosure as defined by the claims.

### GLOSSARY

“device” as used herein means the robotic self-service device described herein.

“gateway” as used herein means a portal, terminal, exit, entry, or an access and/or deposit and withdrawal window.

“robotic manipulator” as used herein means a pre-programmed mechanical device capable of responding to computerized commands and maneuvering objects.

“robotic complex” as used herein means a robotic manipulator, a robotic manipulator grab, and a robotic manipulator base together.

“access device” as used herein means an apparatus for identifying a consumer and providing secure access to vending and/or banking services.

“control unit” as used herein means an apparatus for computing, processing, transmitting, receiving, and caching computer program commands.

“kit” as used herein means the program-apparatus robotic kit.

“vending goods” as used herein means any tangible item including currency, coins, bullions and cassettes.

“vending services” as used herein means the deposition, dispersion, storage, conversion, withdrawal, production, and providing of vending goods; as well as any banking services provided by a self-service device.

“banking services” as used herein means banking transactions such as cash deposit and withdrawal, currency exchange, bullion trade, banknote exchange, providing banking documents, loan documentation acceptance, bank account and credit card application acceptance and processing, payment processing, and safe-deposit box maintenance.

### DETAILED DESCRIPTIONS OF THE DRAWINGS

The device described herein is a structurally-independent, mobile, and compact self-service robotic device for various banking, retail, and vending services. The device is a fully automatic self-service station that is modular and is capable of serving multiple consumers simultaneously at different gateways or service windows on the exterior of the device.

The device is intended particularly for, but not limited to, the following services: cash deposit and withdrawal; currency exchange; credit and debit card dispensary; accepting and issuing mail; precious metal bullion investment and sale; acceptance and exchange of worn-out or suspicious banknotes; various registrations and obtaining of bank documents where the physical presence of a bank employee is not required; lottery and other ticket sales; safe-deposit box services; mail and postage services; general goods vending services; purchase of medical insurance policies for travelers; pension account transactions; information and payment of fines and fees due; loan documentation submission; and bank or credit card applications.

The modular structure and design of the device facilitates quick onsite assembly and installation in shopping malls, transport hubs, townships, campuses, public places and event areas, recreational areas, construction sites, places with high seasonal customer presence, temporary housing establishments, and natural disaster sites. Furthermore, armored cell panels add security.

The modules are cells equipped with interfaces such as gateways, access windows, and apparatuses for performing customer service operations. The cells are fastened quickly and securely to other cells by docking units. The cells make up a rigid frame around the perimeter to create a total housing. The cells have panels that are rigidly fixed to the frame to provide security and prevent unauthorized access to interior materials and apparatuses. The panels may be armored.

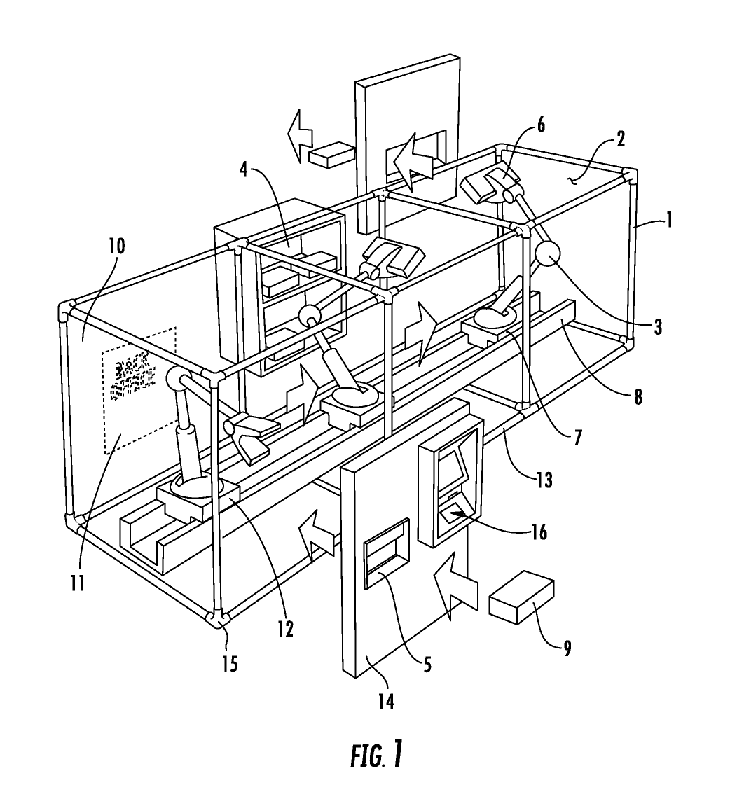

Referring now to FIG. 1, an exemplary embodiment of the interior and exterior of a robotic self-service device is illustrated. In preferred embodiments, the device may be structured with a housing 1. The housing 1 comprises at least one cell 2 and may have more cells 2 to form a modular, portable, and compact structure. Each cell is defined by a frame 13. The frames 13 of each cell 2 may be joined by a frame docking unit 15. Each cell may have a solid siding or may have at least one panel 14 to provide for an interior working area 4 and an exterior working area 10. Panel 14 may also have electrical connectors or outlets. In some embodiments, docking units 15 may comprise element connectors of various shapes and facets. Some docking units 15 along with the frames 13 may have bolt holes drilled into the docking unit 15 to connect to an adjacent frame 13 rod. A bolt may be inserted through the docking unit 15 and into the connector of the frame 13. A bolt with a spigot may be screwed into a connector unit. Cage nuts and a frame riser and corresponding openings in the panels may be present where bolts may be secured into the interior of the frame 13.

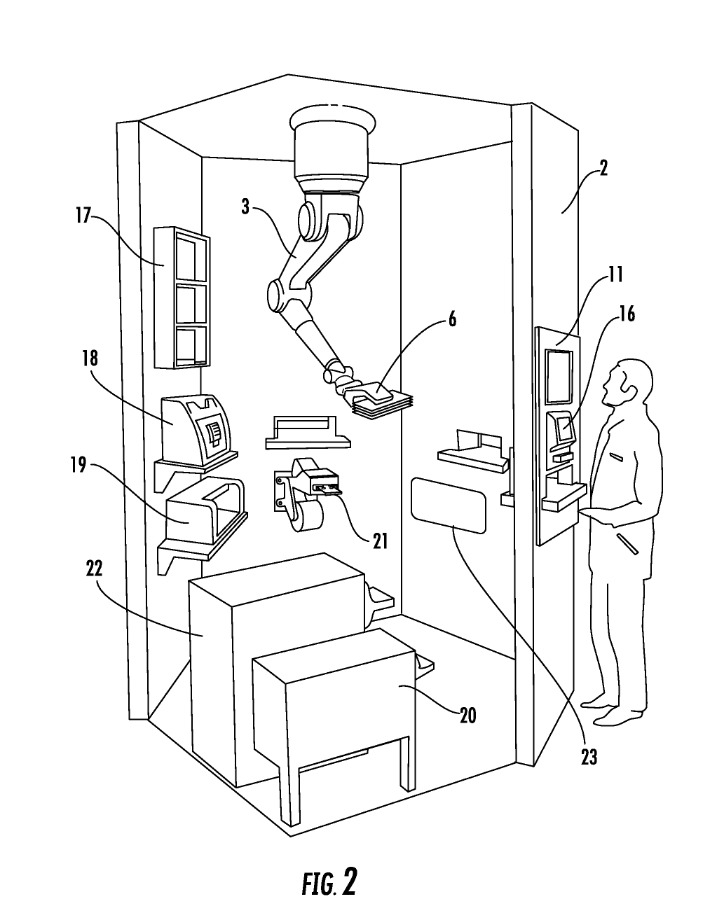

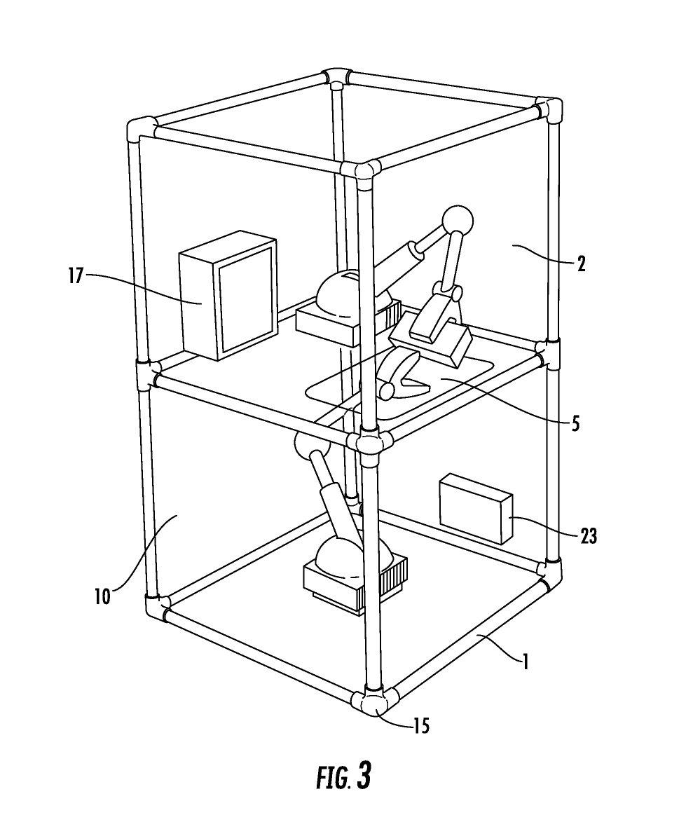

Inside the interior working area 4, the device contains a robotic manipulator 3. The robotic manipulator 3 may have a robotic manipulator grab 6 and may also have a robotic manipulator base 7. The robotic manipulator grab may have sizes and shapes to correspond to the size of the gateway 5 and/or to the size and shape of the objects the robotic manipulator grab 6 may transport. The robotic manipulator base 7 provides a stabilization structure for the robotic manipulator 3 and the robotic manipulator grab 6. This robotic complex may be attached to at least one rail 8. In some embodiments, the base 7 may be fitted to slide or roll along the rail 8. Some embodiments of the device may contain one or more secondary robotic complexes 12. The secondary robotic complexes 12 may work in harmony with or complementary to other secondary robotic complexes 12 or to a general robotic manipulator 3. A robotic manipulator grab 6 may perform multiple dynamic movements to and from working areas 4 and 10 and gateways 5 upon input commands from a consumer and processed by a control unit 23 (illustrated in FIGS. 2 and 3). A control unit may also contain a network connection apparatus to allow for device network access and/or connection to a virtual private network, Ethernet, fax line, wireless Internet, or any other wireless communication. A single rail 8 may accommodate between 1 and 5 secondary robotic complexes 12.

On the exterior working area 10, the device may have one or more gateways 5 through which currency, material objects such as coins, bullions, cassettes and vending goods 9 may be inserted into the device or withdrawn from the device. Working areas 4 and 10 may contain devices for performing operations with material objects and with vending goods 9. Gateways 5 may allow for deposit of objects into the device and placement of the objects by the robotic manipulator grab 6 into predetermined optional storage compartments (illustrated in FIG. 3). Storage compartments may be identified by RFID marks that may be scanned by an RFID scanner in the interior working area 4.

The exterior working area 10 may also have an access window 11. An access window 11 may be any portal by which personnel may access the interior of the device or exit the device. An access window 11 may be a door, particularly in mobile variations of the device. The device may also contain an access device 16. The access device 16 may be a keyboard, keypad, encrypted pin-pad, magnetic card reader, microchip reader, touchless card reader, barcode scanner, biometric identification scanner, or a combination. Panels 14 may be equipped with gateways 5. These gateways 5 may be for communication with service windows or authorized personnel windows 11 that may be on the outer part of the device.

The device may be equipped with additional and optional security features such as surveillance cameras. Devices may also be coupled with a generator system in case of power outages. The device may also be equipped with wheels, chassis, clutch mechanisms, or other means for facilitating easy transportation between venues.

Some embodiments of the device may include receipt or transaction paper printing apparatuses, currency dispenser apparatuses, coin dispensers, banknote counters, coin counters, counterfeit detector apparatuses, object storage spaces, or weight scales. The aforementioned may be present in an interior working area 4 or in an exterior working area 10. The components of a device may be electrically connected to a central power supply or separate power supplies. The components of each cell may be electrically connected.

Referring now to FIG. 2, an exemplary single-cell robotic self-service device is illustrated. A device may contain various parts specific for a particular purpose. The various parts may be electronically connected or in communication with a control unit 23 that may have a processor and memory. A housing 1 may define the exterior area and the interior area with the exterior panels of the housing being the facets of the device. An access window 11 and an access device 16 may be present on a panel of the cell housing 1. A consumer may approach the access device 16 and may initiate service by swiping a card, entering a code, or passing a biometric scan.

In the example of currency exchange, deposit, and withdrawal, a device may be equipped with a storage compartment 17. The storage compartment 17 may be a secured structure for organizing and storing currency. The storage compartment 17 may have divided sections for multiple currency types. A currency counter apparatus 18 may also be implemented into the device. The currency counter apparatus 18 may accept and/or provide a desired currency based on a given exchange rate and amount. A counterfeit detector apparatus 19 may also be included in a device. The counterfeit detector apparatus 19 may optically or digitally scan incoming currency and may be preprogrammed to identify specific parts of currency to determine its authenticity. Examples of preferred counterfeit detector apparatuses 19 are those having an application programming interface to be in communication with software in a control unit as well as a physical interface for counting and scanning currency. A counterfeit detector apparatus 19 may be standard models such as a DORS 800. These counterfeit detector apparatuses 19 may be utilized for verification of country of origin, currency organization, and currency authenticity. If the currency is authentic, then the robotic manipulator 3 will be signaled or commanded to accept the currency from the counterfeit detector apparatus 19 and use its robotic manipulator grab 6 to place the currency in a storage compartment 17 or in a currency receptacle 22. If the currency is not authentic, then an alert system may be activated. A currency dispenser apparatus 20 may provide the proper amount of exchanged currency for the robotic manipulator 3 to obtain with the robotic manipulator grab 6 and submit to an access window 11. A printing apparatus 21 may print a receipt for the transaction and may also print a record of the transactions for that cell for that business day.

The apparatuses and components in a device may be mounted onto a panel or may be free standing. Furthermore, if a device is integrated with a transportation means such as a cargo container on a platform, the transportation means may be modified to permanently attach a device while allowing consumer access without any need to open the cargo container.

Referring now to FIG. 3, an alternative exemplary embodiment of the interior of a robotic self-service device is illustrated. A modular device is shown in the form of two cells 2 stacked in a vertical configuration with a gateway 5 between the cells 2. The housing 1 is defines the interior working area 4. The cells 2 are connected by frame docking units 15 at each vertex or corner in order to secure the cells 2 together.

Inside, there may be one or more robotic complexes controlled by a control unit 23. Control units 23 may contain a memory block with programs for bank card transactions, third party payments, and currency exchanges. The control unit may contain a management system that processes codes to effectuate the functions selected by the consumer at a gateway 5.

The control unit 23 may effectuate the following process for currency exchange. A consumer approaches the device, selects a process for currency exchange on a display at a gateway. The management system obtains the process code for currency exchange with the variables selected by the consumer. The management system determines the first step in the process to open the consumer gateway and transport the corresponding response code to the management system. The management system determines the next step and effectuates the command to indicate deposit of material into the gateway slot. The management system receives a signal from the client gateway slot sensors when objects or cash are deposited into the slot. The management system signals for the gateway to close. Then the robotic manipulator complex obtains, transfers, and releases the deposited objects or cash, according to transmitted commands and coordinates, into a validator slot on the interior working area. The robotic manipulator functions based on coordinates and commands to retrieve the desired currency, count it, validate it, and then deposit the exchanged currency to the gateway where the consumer may retrieve the currency or other objects. In some examples, the device may supply the consumer with a transaction receipt at the conclusion of the transaction.

The device may be utilized for a wide variety of consumer and vending services. One device may provide multiple types of services to multiple consumers simultaneously. For example, the device may be used for currency exchange. A consumer may select a currency exchange service to initiate robotic complexes to use a cash dispensing gateway to obtain and transmit different currencies contained within a device cell. If the transaction is a non-cash bank payment, then robotic complexes may not be utilized.

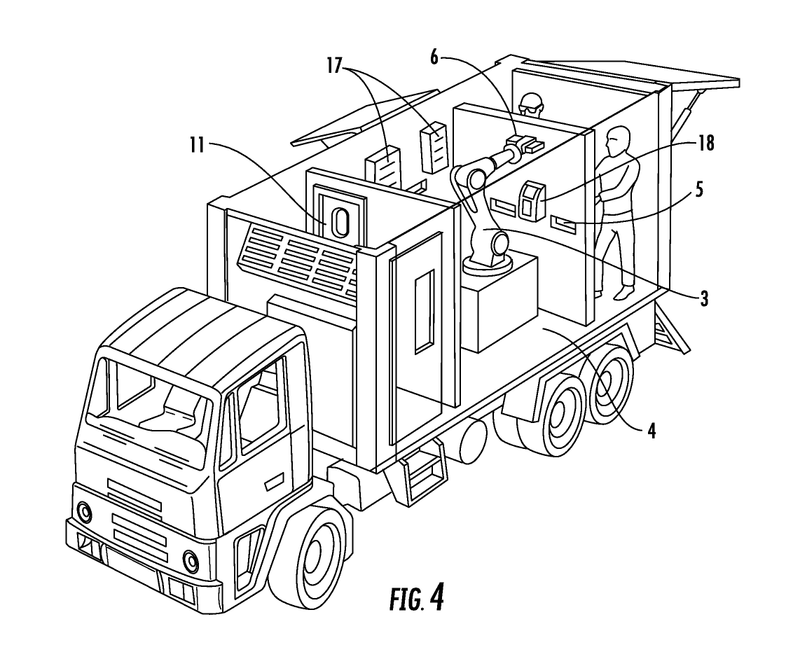

Referring now to FIG. 4, an exemplary mobile robotic self-service device is illustrated. In this figure a housing is defined by a shipping container mounted onto a vehicle. A cargo or shipping container may provide the requisite stability, strength, and armor to secure a device. A cargo container may be transported and manipulated with forklifts, dollies, and other standard machinery typically used to handle cardo containers. Examples of cargo containers are those with standard sizes of 1C, 1CC, 1CCC, 1A, 1AA, and 1AAA

An access window 11 may be present between cells and on the other face of the cargo container. Multiple storage compartments 17 may be present. In an interior working area 4, a single robotic manipulator grab 6 on a robotic manipulator 3 may obtain and deposit vending goods throughout multiple cells in a cargo container and through a gateway 5. For a complete customer service experience, a device may also contain a currency counter apparatus 18. This configuration allows for secure temporary banking and vending sites such as at festivals, marathons, shows, and emergency and natural disaster areas.

A device may be mounted onto a transportation means or housed within a transportation means. A device may be fixably or removably attached. A transportation means may be aircraft, watercraft, or land vehicles. Examples of transportation means include cruise ships, aircraft carriers, yachts, dinner cruise boats, river cruise boats, sailboats, houseboats, airplanes, helicopters, trains, busses, commercial trucks, cargo containers loaded onto another transportation device, and recreational vehicles. In some embodiments, additional housings or securing mechanisms may be implemented to aid with fitting and securing the device to or within the transportation means so that consumers may access the device while the interior valuables are protected from potential theft or tampering. The device may be transported by or within the transportation means and may be unloaded to a specified destination site. If a device may be unloaded from a transportation means, then at least one person may load the device onto a forklift, dolly, or wheeled platform. Some device cells may have a wheel system built in. A device may be transported as a multicellular module or may be broken down into single cells and re-assembled into a multicellular module at arrival of a specific destination. In other embodiments, the device may be housed within the transportation device and remain fixed within the transportation device upon arrival to a specific destination. In preferred embodiments, a transportation means has a carrying or towing capacity of at least 1 metric ton.

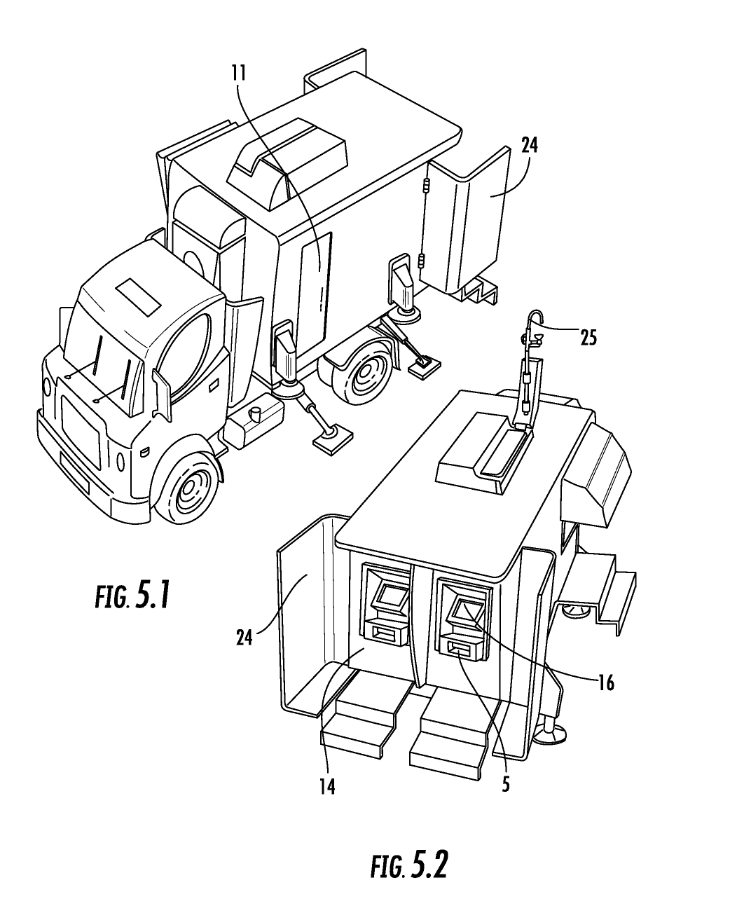

Referring now to FIG. 5.1, a front and side view of an alternative mobile robotic self-service device is illustrated. Armored panels 24 may be in the form of a solid side panel or may be a hinged panel such as a door that may be secured. An access window 11 may also be present in the form of a door for authorized personnel to enter and exit the device. Exterior peripheral components may be added such as power supply units, solar power panels, and shade awnings for consumer comfort and protection from sun, snow, and rain while utilizing the device.

Referring now to FIG. 5.2, a rear view of an alternative mobile robotic self-service device is illustrated. Armored panels 24 may be opened to allow consumer access to the access device 16 and gateway 5 at the exterior working area 10. Furthermore, a network connection 25 may be integrated into the device to provide wireless communication between other devices, a central control cell, the operating company's master computer system, satellites, routers, and local area networks.

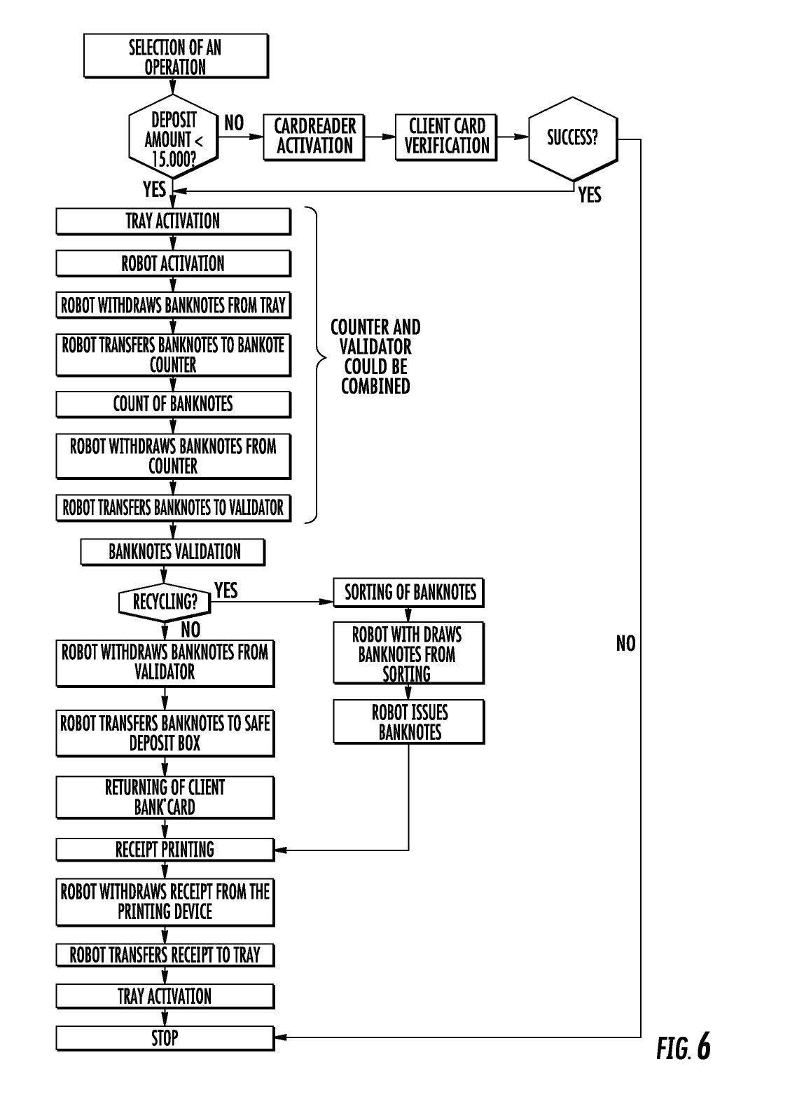

Referring now to FIG. 6, exemplary method steps for a cash-in or deposit operation are illustrated. For making a deposit, the consumer may enter the required information and deposit amount to the gateway via an access device. Transaction data may be transferred to the control unit. After processing and checking requests, a program for the robotic manipulator may be selected. A robotic manipulator grab may move to the gateway, take deposit, and consequently transfer the deposit to the counterfeit detector apparatuses and currency counter apparatuses if needed. These devices may transfer transaction data to the control unit confirming the authenticity of banknotes and the total deposit amount. After the incoming command, a robotic manipulator grab may move to a cash receptacle unit. The robotic manipulator grab may move to the printing device and pass a printed transaction document or receipt to the consumer via the gateway.

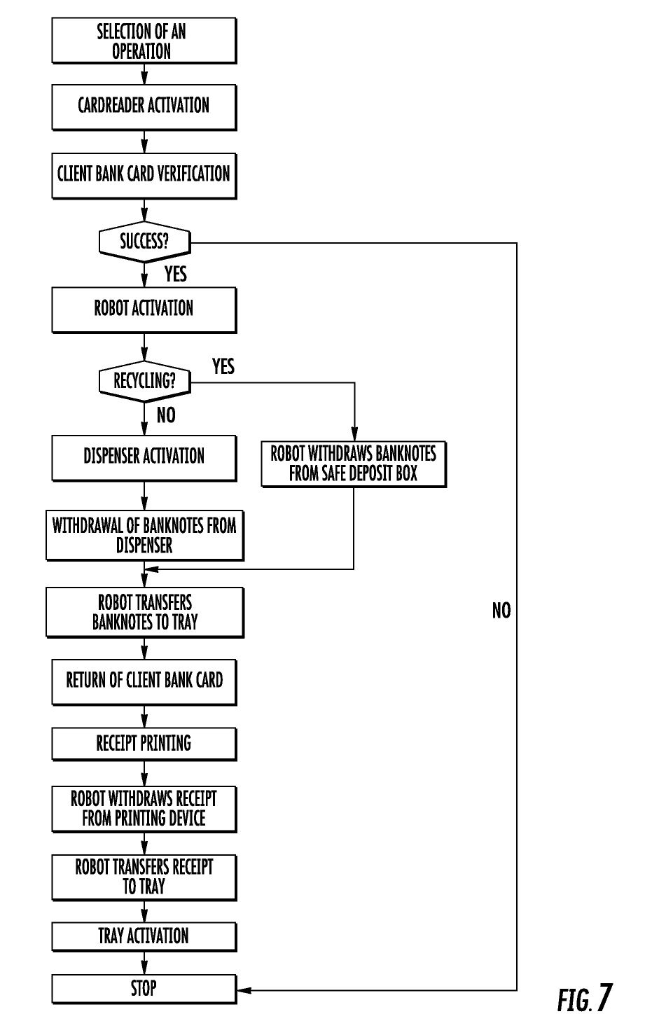

Referring now to FIG. 7, exemplary method steps for a cash-out or withdrawal operation are illustrated. Another example is using the device for cash withdrawal. If there is a request to withdraw from the consumer account, the consumer may obtain a customer identification device and/or input device, then insert his/her bank card and specifies the amount of money he/she wanted to withdraw, using an encrypted pin-pad. Transaction data may be transferred to the control unit. After processing and checking request, a program for the robot-manipulator is selected. The control unit transfers commands to the one of working areas. These working areas may be equipped with a currency dispenser apparatus and a device for printing of the transaction data documents. A robotic manipulator grab moves to the currency dispenser apparatus, obtains a required amount of cash and moves back to the one of the gateways. A robotic manipulator grab moves to the device for receipts printing and passes a printed document to the consumer through the gateway.

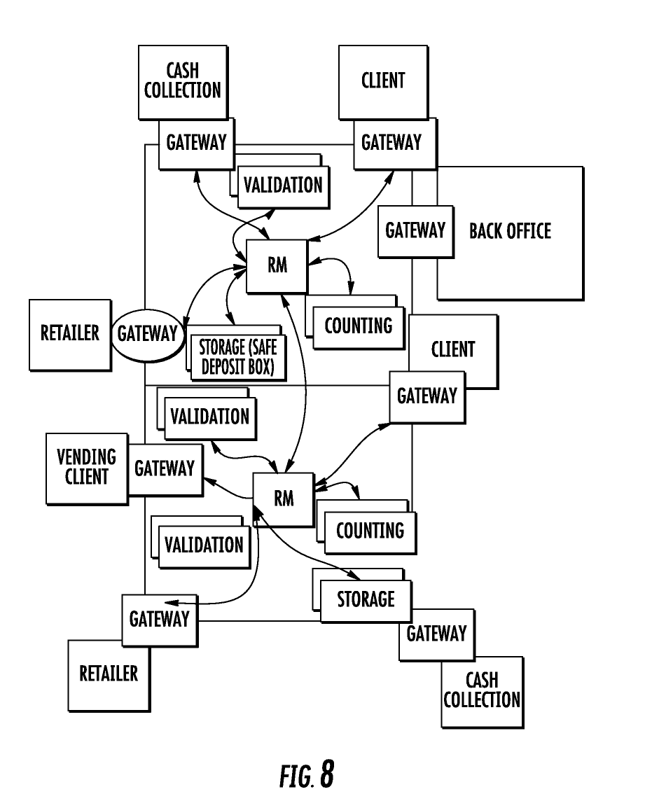

Referring now to FIG. 8, exemplary method steps for functionality processes of a robotic self-service device are illustrated. The flow chart shows more specifically the simultaneous interactions at multiple gateways on a single device. Multiple consumers may be served through a single device, and in some embodiments, the deposits or vending goods made by a consumer may be relayed or transferred to a simultaneous consumer at a separate gateway. Retail, cash collection, and vending may be performed at individual gateways or may be performed all at a single multipurpose gateway. Tasks such as currency counting, cash validation, and multi-currency storage may occur simultaneously for multiple consumers. Lasers and sensors may be implemented to aid robotic manipulators in not mixing the tasks commanded by the consumers. Authorized personnel may have access to the device through the access window from a back office.

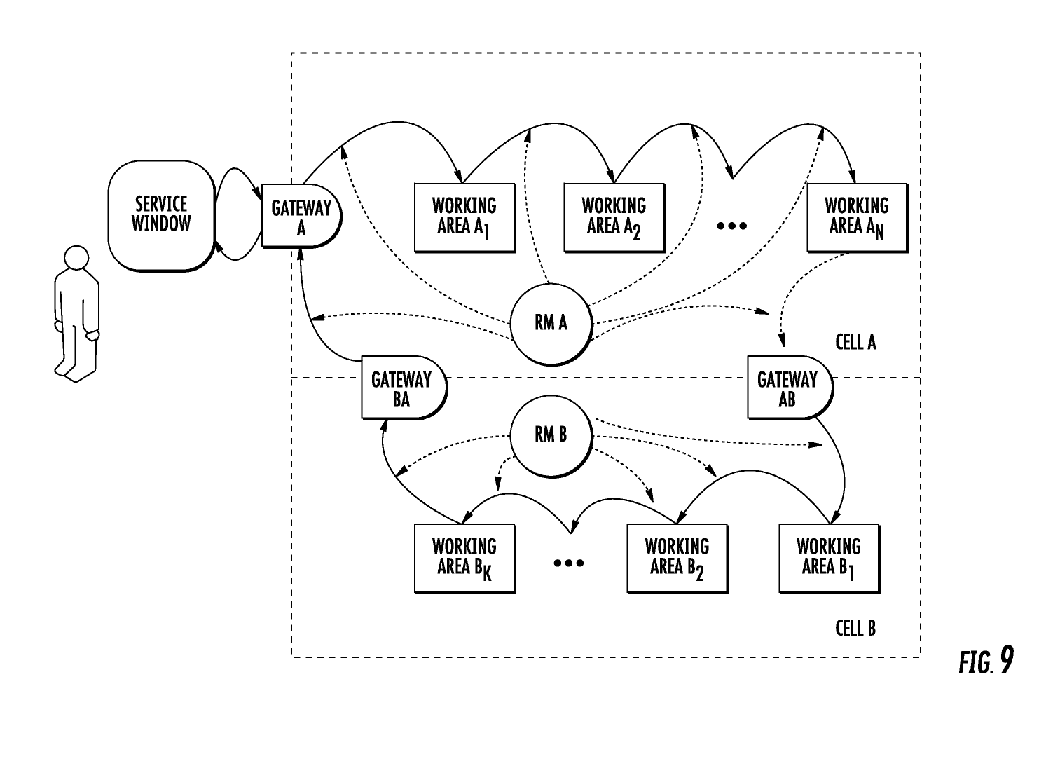

Referring now to FIG. 9, an exemplary schematic for movement of material objects or vending goods within a robotic self-service device is illustrated. In FIG. 9, the solid lines represent the flow of currency, material objects such as coins, bullions, cassettes, or vending goods. The broken lines represent the operation and process flow performed by robotic manipulator complexes in a particular cell. In some embodiments, a single robotic manipulator complex could service multiple cells when the robotic manipulator complex moves along a rail or some other type of transportation or movement device. In some embodiments, a robotic manipulator complex may perform work, functions, or services in two or more cells and may synchronize or co-operate with one or more secondary robotic manipulator complexes. The robotic manipulator complex may attend to multiple interior and exterior working areas while currency, material objects such as coins, bullions, cassettes and vending goods may be transferred from a gateway. A consumer may deposit and withdraw or receive currency, material objects such as coins, bullions, cassettes, and vending goods from the same service window.

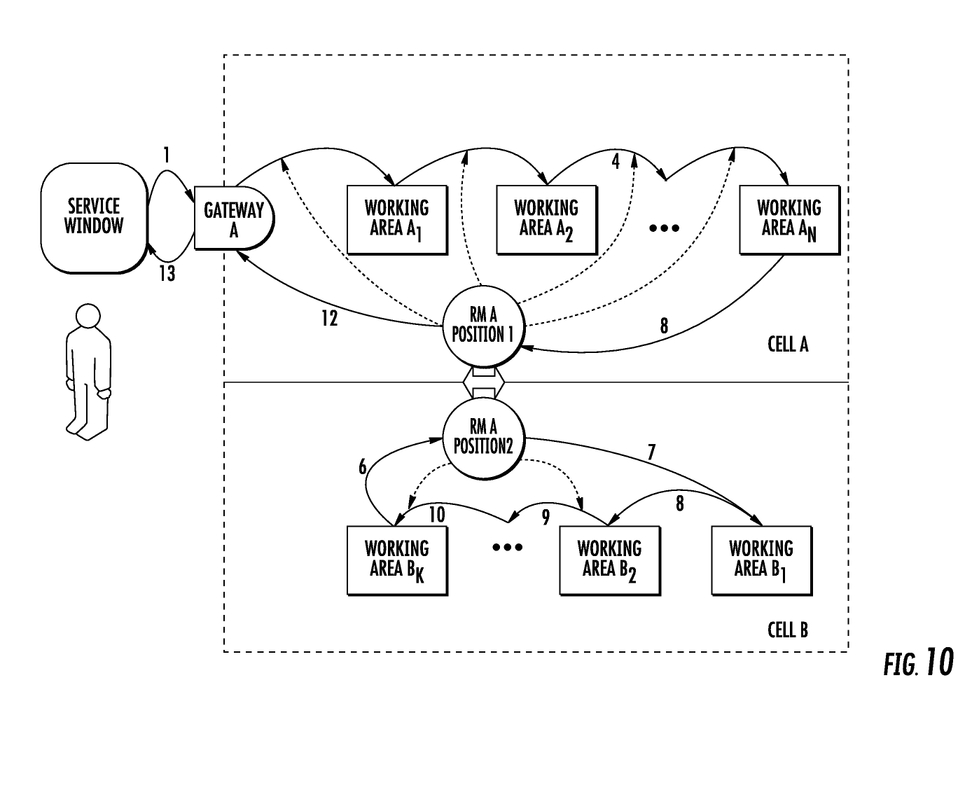

Referring now to FIG. 10, an exemplary schematic for movement of robotic manipulator between the cells is illustrated. Some devices may have multiple working areas. In some embodiments, the purpose of each working area may be defined by a designated and/or adopted function, or client type. In particular, customer service operations may be performed by a program-apparatus robotic kit. The kit facilitates the transfer of currency and coins, material objects and vending goods between a service window and working areas. These transfers may be executed only through a gateway. A gateway may be a terminal or front part of an ATM, an entrance into a cell, window between adjacent cells, a deposit slot, a withdrawal slot, printed document dispenser, card slot or card reader, an opening to deposit or withdraw currency, material objects and vending goods. A gateway may be multipurpose. In some embodiments, access to objects, currency and vending goods may be performed by the kit. The interaction between the consumer and the kit may occur only at the device's service window.

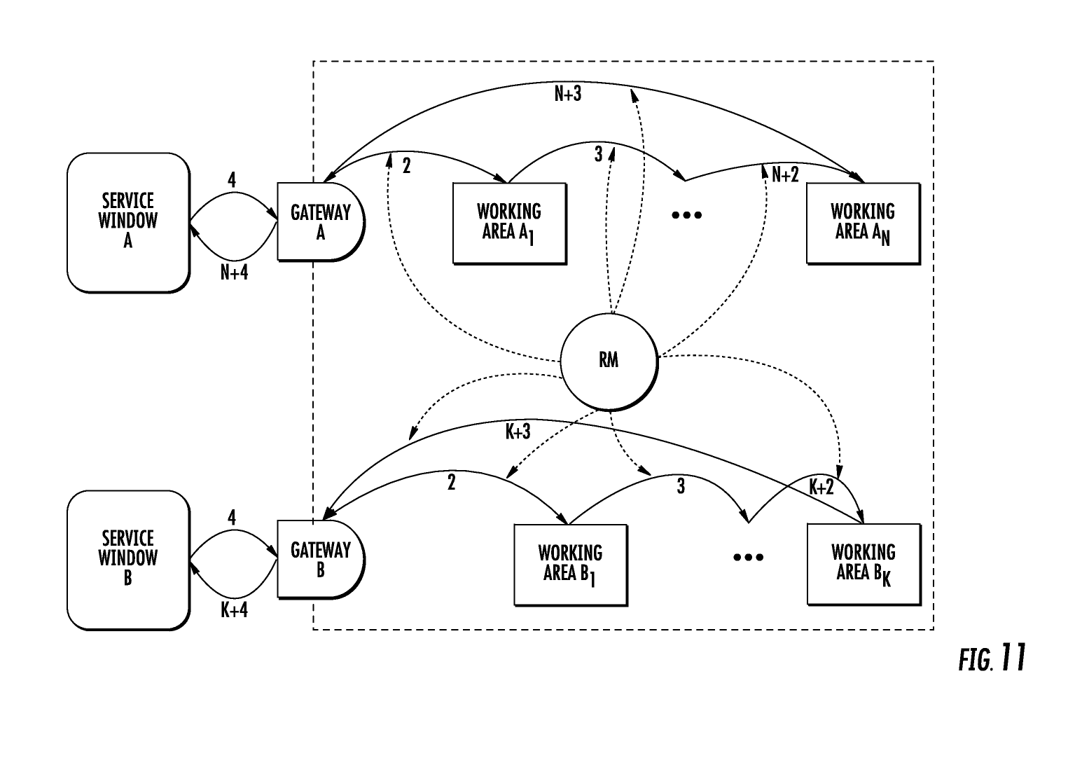

Referring now to FIG. 11, an exemplary schematic for client and service gateways is illustrated. The primary types of gateways are client or consumer gateways and service gateways. Client gateways allow for initiation of transfer of currency, material objects and vending goods between an access window, working areas, and other gateways via the kit. A task may be completed at one working area, a robotic complex may grab and move the currency, material objects and vending goods to a different working area to complete a new task on some or all of the currency, material objects and vending goods retrieved from the previous working area. When the tasks are completed, the robotic complex may retrieve the currency, material objects and vending goods from a working area and deposit the vending goods into or at a gateway for a consumer to accept.

There may be various types of service gateways. One example is a service gateway for cash collection. A mechanism provides movement of packaged currency in cassettes, bags, or envelopes and printed transaction documents and receipts between a cash collector service window and a working area. The mechanism may be controlled by corresponding commands processed by a control unit. A vending service gateway may be used for loading and unloading vending goods. A mail service gateway may be used for loading and unloading of mail. Service gateways may be multipurpose. Authorized personnel may have access to the gateways.

There may be various types of consumer gateways. A cash client gateway may move currency deposits and printed material between a consumer and the cell working area. A deposit client gateway may have a mechanism to provide delivery of objects, vending goods, and currency. These deposits may be packed in a deposit box identified by an RFID mark. The gateway mechanism may be controlled by corresponding commands from a control unit. A mail client gateway may have a mechanism that provides movement of mail between a service window and cell working area. The gateway may be controlled by commands processed by a control unit. The client gateway may have a mechanism that transfers vending goods from a cell working area to a consumer. Commands may be processed by a control unit.

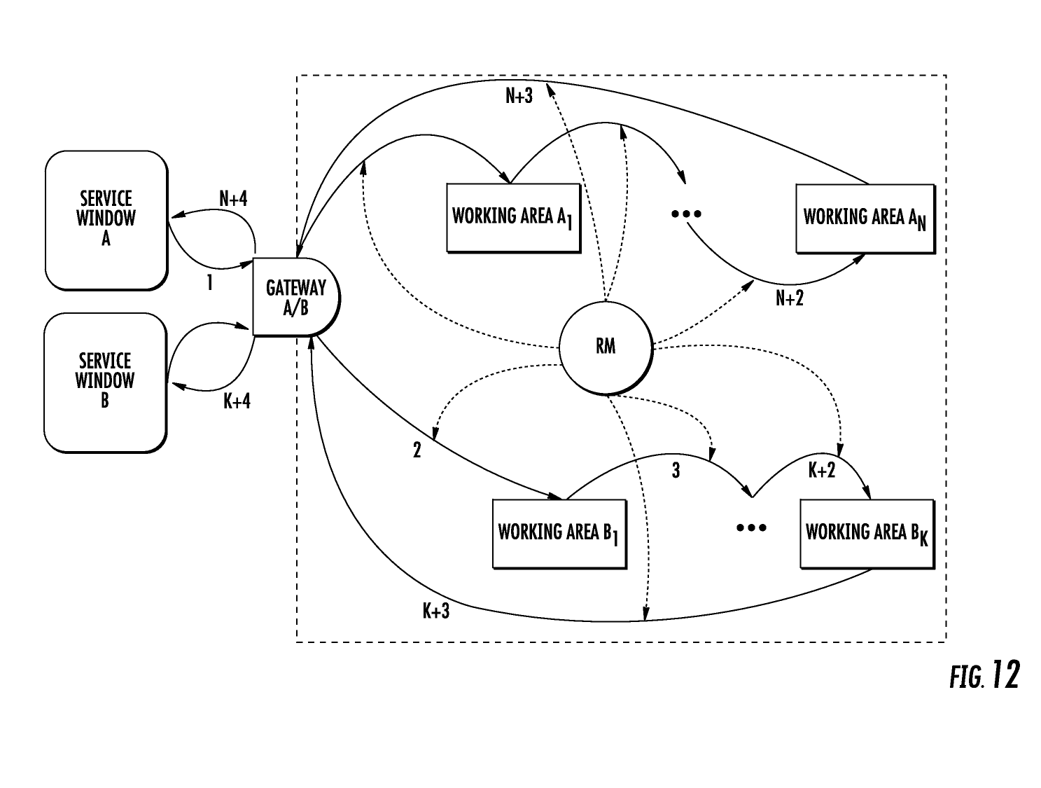

Referring now to FIG. 12, an exemplary schematic for robotic self-service device processes is illustrated. In this example, a single gateway may accept and deposit vending goods, currency, and objects to multiple service windows. The device may contain a single robotic complex to delegate duties to different working areas and then transfer the product to the gateway which may then allow a consumer to retrieve the ordered receipt, object, currency, or vending goods via a single service window. A single gateway may allow distribution and acceptance of many types of deposits from multiple consumers simultaneously. The gateways may have service doors or windows.

### CONCLUSION

The foregoing is a complete description of the methods and apparatuses for the robotic self-service vending device. However, it is to be understood that the present invention is not limited to the particular descriptions disclosed and shown in the drawings. The present invention also comprises any modifications or equivalents within the scope of the claims.

What is claimed is:

1. A robotic self-service device, the device comprising
an electrically-powered robotic complex;
an access device electronically connected to a control unit, the control unit comprising a processor, random access memory, and digital storage;
a gateway;
an interior working area;
a storage compartment;
an access window;
the device having a portable modular structure wherein the device is defined by a three-dimensional frame with sides and vertices having attached panels providing facets and providing an interior and an exterior defining a device cell; and
a frame docking unit at frame vertices for mechanically attaching a cell onto each facet of a three-dimensional cell.

2. The device of claim 1 further comprising a secondary robotic complex.

3. The device of claim 1 wherein the cell is attached at frame vertices to an additional cell frame vertices to provide a modular vending device.

4. The device of claim 1 further comprising a network connection apparatus and network access provided to and accepted by a control unit.

5. The device of claim 1 further comprising a storage compartment, a currency receptacle, a currency dispenser apparatus electronically connected to and in communication with a control unit.

6. The device of claim 5 further comprising a counterfeit detector apparatus electronically connected to and in communication with a control unit.

7. The device of claim 5 further comprising a currency counter apparatus electronically connected to and in communication with a control unit.

8. The device of claim 5 further comprising a printing apparatus electronically connected to and in communication with a control unit.

9. The panel of claim 1 wherein the panel provides a gateway for the deposition and withdrawal of vending goods.

10. The panel of claim 1 wherein the panel is armored with a solid, dense metal.

11. A method for providing portable vending services, the method steps comprising fixing the device of claim 1 to a transportation means and transporting the device to a desired location, connecting the control unit to a power supply, the control unit being connected to a network and whereby the access device accepts commands from consumers;
a consumer requesting vending goods or vending services by inputting commands on an access device;
the access device sending the commands to the control unit;
the control unit processing the commands and sending the processed commands to the robotic complex;
the robotic complex accepting the processed commands and executing the processed commands; and
the robotic complex completing vending services and dispensing the vending goods at a gateway.

12. The method of claim 11 whereby the robotic complex executes processed commands from a control unit and performs tasks at interior working areas.

13. The method of claim 11 whereby the robotic complex coordinates tasks with a secondary robotic complex.

14. The method of claim 11 wherein the control unit contains preprogrammed algorithms to translate a consumer's commands into robotic complex processes to result in providing vending goods and vending services.

15. The method of claim 11 wherein the transportation means is selected from a group consisting of (a) watercraft, (b) aircraft, and (c) land vehicle.

16. A method for providing simultaneous vending services to multiple consumers, the method comprising the steps
a consumer approaching one cell of the device of claim 3 wherein the cell comprises an access device and a gateway fixably integrated into the device cell panel;
at least one more consumer approaching a second cell of the device of claim 3 wherein the cell comprises an access device and a gateway fixably integrated into the device cell panel;
all consumers initiating access and inputting commands on the access device;
the control unit processing commands;
the control unit signaling the commands to the robotic complex;
the robotic complex executing the commands;
the robotic complex providing vending goods at each gateway; and
the consumers retrieving the vending goods at the gateway.

17. The method of claim 16 further comprising a secondary robotic complex in communication with the control unit and in coordination with the robotic complex.

18. The method of claim 16 whereby the robotic complex completes tasks in a single interior working area, and the secondary robotic complex completes tasks in a separate interior working area.

19. The method of claim 16 further comprising an additional cell attached to a frame docking unit.

20. The method of claim 16 further comprising the step of a printing apparatus printing a receipt for each consumer.

21. The method of claim 18 whereby the robotic complex moves along a rail through multiple cells.

22. The method of claim 21 whereby from 1 to 5 robotic complexes move along the rail through multiple cells.

23. The method of claim 16 wherein the simultaneous vending services are banking services.
